(19) United States
(12) Patent Application Publication
(10) Pub. No.: US 2026/0329907 A1
(43) Pub. Date: Oct. 22, 2026

(54) Dynamic Use Case Driven Foundation Model Selection

(71) Applicant: International Business Machines Corporation, Armonk, NY (US)

(72) Inventors: Joseph Kozhaya, Morrisville, NC (US); Andrew R. Freed, Cary, NC (US); Charles E. Beller, Baltimore, MD (US); Donna K. Byron, Petersham, MA (US)

(21) Appl. No.: 19/184,422

(22) Filed: Apr. 21, 2025

(51) Int. Cl. G06F 16/334; G06F 16/3329

(52) U.S. Cl. CPC G06F 16/334; G06F 16/3329

(57) ABSTRACT

Use case driven foundation model ranking and selection is provided. Each respective foundation model of particular foundation models that support a use case corresponding to a prompt is ranked in a list from a highest ranking foundation model to a lowest ranking foundation model based on a ranking score associated with each respective foundation model. A defined number of top-ranked foundation models of the particular foundation models that support the use case corresponding to the prompt is selected from the list to generate a number of responses to the prompt. The prompt is run against the defined number of top-ranked foundation models to generate the number of responses to the prompt. A selection by a user is tracked to identify which foundation model response was most relevant to the use case and prompt. A ranking score of the foundation model generating the most relevant response is increased.

### BACKGROUND

The disclosure relates generally to foundation models and more specifically to selecting foundation models.

Foundation models are artificial intelligence (AI) models trained on immense datasets and can perform a wide range of general tasks. Foundation models serve as the base for building more specialized applications.

The flexibility and massive size of foundation models set them apart from traditional machine learning models, which are trained on smaller datasets to accomplish specific tasks such as object detection, trend forecasting, or the like. Foundation models employ transfer learning to apply the knowledge learned from one task to another. This makes foundation models fit for more expansive domains such as computer vision, natural language processing, speech recognition, and the like.

Foundation models can be either unimodal or multimodal. Unimodal foundation models are designed to manage a single type of data, such as receiving text inputs and generating text outputs. Multimodal foundation models can combine information from multiple modalities, such as taking a text prompt and creating an image or producing written transcripts from a voice recording.

A user can provide a prompt to tailor a foundation model to perform a certain task. The prompt may come in the form of task-related instructions and task-relevant examples that guide a foundation model, allowing the foundation model to gain context and generate a plausible output. The most common foundation models today are large language models (LLMs).

### SUMMARY

According to one illustrative embodiment, a method is provided. A computer ranks each respective foundation model of particular foundation models that support a use case corresponding to a prompt in a list from a highest ranking foundation model to a lowest ranking foundation model based on a ranking score associated with each respective foundation model. The computer selects a defined number of top-ranked foundation models of the particular foundation models that support the use case corresponding to the prompt from the list to generate a number of responses to the prompt. The computer runs the prompt against the defined number of top-ranked foundation models to generate the number of responses to the prompt. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a foundation model management system in accordance with an illustrative embodiment;

FIG. 3 is a diagram illustrating an example of a prompt in accordance with an illustrative embodiment; and

FIGS. 4A-4C are a flowchart illustrating a process for use case driven foundation model ranking and selection in accordance with an illustrative embodiment.

### DETAILED DESCRIPTION

Illustrative embodiments provide a computer-implemented method. A computer ranks each respective foundation model of particular foundation models that support a use case corresponding to a prompt in a list from a highest ranking foundation model to a lowest ranking foundation model based on a ranking score associated with each respective foundation model. The computer selects a defined number of top-ranked foundation models of the particular foundation models that support the use case corresponding to the prompt from the list to generate a number of responses to the prompt. The computer runs the prompt against the defined number of top-ranked foundation models to generate the number of responses to the prompt. As a result, illustrative embodiments provide a technical effect of dynamically ranking and selecting foundation models based on use case associated with a prompt submitted by a user so that the user does not need to select a foundation model before receiving a foundation model-generated response to the prompt. Thus, illustrative embodiments automatically identify for a user which foundation models are best for a particular use case corresponding to a received prompt from the user.

In addition, the computer receives the number of responses to the prompt generated by the defined number of top-ranked foundation models. The computer sends the number of responses to the prompt generated by the defined number of top-ranked foundation models to a client device user for review. As a result, illustrative embodiments provide a technical effect of sending the number of responses to the prompt generated by the defined number of top-ranked foundation models to a client device user for review.

Further, the computer receives a selection from the client device user of one response of the number of responses to the prompt generated by one particular foundation model of the defined number of top-ranked foundation models. The computer increases the ranking score associated with the one particular foundation model that generated the one response selected by the client device user by a defined value in an n-dimension tensor. As a result, illustrative embodiments provide a technical effect of increasing the ranking score associated with the one particular foundation model that generated the one response selected by the client device user by a defined value in an n-dimension tensor.

Furthermore, the computer sends a rating scale to the client device user to rate each of the number of responses to the prompt not selected by the client device user. The computer receives a rating from the client device user for each of the number of responses to the prompt not selected by the client device user. The computer adjusts the ranking score associated with certain foundation models that generated each of the number of responses to the prompt not selected by the client device user in an n-dimension tensor based on the rating received from the client device user for each of the number of responses to the prompt not selected. As a result, illustrative embodiments provide a technical effect of adjusting the ranking score associated with certain foundation models that generated each of the number of responses to the prompt not selected by the client device user in the n-dimension tensor based on the rating received from the client device user for each of the number of responses to the prompt not selected.

Moreover, the computer assigns the ranking score to each foundation model of a plurality of foundation models based on a set of use cases supported by a particular foundation model of the plurality of foundation models using corresponding descriptions and tags associated with each foundation model. The computer records the ranking score assigned to and the set of use cases supported by each foundation model of the plurality of foundation models in an n-dimensional tensor. As a result, illustrative embodiments provide a technical effect of recording the ranking score assigned to and the set of use cases supported by each foundation model of the plurality of foundation models in an n-dimensional tensor.

The computer also receives the prompt that contains a set of details from a client device user. The set of details includes at least one of an instruction, a set of examples, a context, and a question. The computer extracts the set of details from the prompt in response to receiving the prompt. As a result, illustrative embodiments provide a technical effect of extracting the set of details that includes at least one of an instruction, a set of examples, a context, and a question from the prompt in response to receiving the prompt.

In addition, the computer performs an analysis of a set of details extracted from the prompt. The computer identifies the use case corresponding to the prompt based on the analysis of the set of details extracted from the prompt. As a result, illustrative embodiments provide a technical effect of identifying the use case corresponding to the prompt based on the analysis of the set of details extracted from the prompt.

Further, the computer performs a search of an n-dimensional tensor. The computer identifies the particular foundation models of a plurality of foundation models that support the use case corresponding to the prompt based on the search of the n-dimensional tensor. The computer identifies the ranking score associated with each respective foundation model of the particular foundation models that support the use case corresponding to the prompt based on the search of the n-dimension tensor. As a result, illustrative embodiments provide a technical effect of identifying the ranking score associated with each respective foundation model of the particular foundation models that support the use case corresponding to the prompt based on the search of the n-dimension tensor.

A computer system comprises a processor set, one or more computer-readable storage media, and program instructions stored on the one or more computer-readable storage media to cause the processor set to perform operations. The computer system ranks each respective foundation model of particular foundation models that support a use case corresponding to a prompt in a list from a highest ranking foundation model to a lowest ranking foundation model based on a ranking score associated with each respective foundation model. The computer system selects a defined number of top-ranked foundation models of the particular foundation models that support the use case corresponding to the prompt from the list to generate a number of responses to the prompt. The computer system runs the prompt against the defined number of top-ranked foundation models to generate the number of responses to the prompt. As a result, illustrative embodiments provide a technical effect of dynamically ranking and selecting foundation models based on use case associated with a prompt submitted by a user so that the user does not need to select a foundation model before receiving a foundation model-generated response to the prompt. Thus, illustrative embodiments automatically identify for a user which foundation models are best for a particular use case corresponding to a received prompt from the user.

In addition, the computer system receives the number of responses to the prompt generated by the defined number of top-ranked foundation models. The computer system sends the number of responses to the prompt generated by the defined number of top-ranked foundation models to a client device user for review. As a result, illustrative embodiments provide a technical effect of sending the number of responses to the prompt generated by the defined number of top-ranked foundation models to a client device user for review.

Further, the computer system receives a selection from the client device user of one response of the number of responses to the prompt generated by one particular foundation model of the defined number of top-ranked foundation models. The computer system increases the ranking score associated with the one particular foundation model that generated the one response selected by the client device user by a defined value in an n-dimension tensor. As a result, illustrative embodiments provide a technical effect of increasing the ranking score associated with the one particular foundation model that generated the one response selected by the client device user by a defined value in an n-dimension tensor.

Furthermore, the computer system sends a rating scale to the client device user to rate each of the number of responses to the prompt not selected by the client device user. The computer system receives a rating from the client device user for each of the number of responses to the prompt not selected by the client device user. The computer system adjusts the ranking score associated with certain foundation models that generated each of the number of responses to the prompt not selected by the client device user in an n-dimension tensor based on the rating received from the client device user for each of the number of responses to the prompt not selected. As a result, illustrative embodiments provide a technical effect of adjusting the ranking score associated with certain foundation models that generated each of the number of responses to the prompt not selected by the client device user in the n-dimension tensor based on the rating received from the client device user for each of the number of responses to the prompt not selected.

Moreover, the computer system assigns the ranking score to each foundation model of a plurality of foundation models based on a set of use cases supported by a particular foundation model of the plurality of foundation models using corresponding descriptions and tags associated with each foundation model. The computer system records the ranking score assigned to and the set of use cases supported by each foundation model of the plurality of foundation models in an n-dimensional tensor. As a result, illustrative embodiments provide a technical effect of recording the ranking score assigned to and the set of use cases supported by each foundation model of the plurality of foundation models in an n-dimensional tensor.

A computer program product comprises one or more computer-readable storage media and program instructions stored on the one or more computer-readable storage media to perform operations. A computer ranks each respective foundation model of particular foundation models that support a use case corresponding to a prompt in a list from a highest ranking foundation model to a lowest ranking foundation model based on a ranking score associated with each respective foundation model. The computer selects a defined number of top-ranked foundation models of the particular foundation models that support the use case corresponding to the prompt from the list to generate a number of responses to the prompt. The computer runs the prompt against the defined number of top-ranked foundation models to generate the number of responses to the prompt. As a result, illustrative embodiments provide a technical effect of dynamically ranking and selecting foundation models based on use case associated with a prompt submitted by a user so that the user does not need to select a foundation model before receiving a foundation model-generated response to the prompt. Thus, illustrative embodiments automatically identify for a user which foundation models are best for a particular use case corresponding to a received prompt from the user.

In addition, the computer receives the number of responses to the prompt generated by the defined number of top-ranked foundation models. The computer sends the number of responses to the prompt generated by the defined number of top-ranked foundation models to a client device user for review. As a result, illustrative embodiments provide a technical effect of sending the number of responses to the prompt generated by the defined number of top-ranked foundation models to a client device user for review.

Further, the computer receives a selection from the client device user of one response of the number of responses to the prompt generated by one particular foundation model of the defined number of top-ranked foundation models. The computer increases the ranking score associated with the one particular foundation model that generated the one response selected by the client device user by a defined value in an n-dimension tensor. As a result, illustrative embodiments provide a technical effect of increasing the ranking score associated with the one particular foundation model that generated the one response selected by the client device user by a defined value in an n-dimension tensor.

Furthermore, the computer sends a rating scale to the client device user to rate each of the number of responses to the prompt not selected by the client device user. The computer receives a rating from the client device user for each of the number of responses to the prompt not selected by the client device user. The computer adjusts the ranking score associated with certain foundation models that generated each of the number of responses to the prompt not selected by the client device user in an n-dimension tensor based on the rating received from the client device user for each of the number of responses to the prompt not selected. As a result, illustrative embodiments provide a technical effect of adjusting the ranking score associated with certain foundation models that generated each of the number of responses to the prompt not selected by the client device user in the n-dimension tensor based on the rating received from the client device user for each of the number of responses to the prompt not selected.

Moreover, the computer assigns the ranking score to each foundation model of a plurality of foundation models based on a set of use cases supported by a particular foundation model of the plurality of foundation models using corresponding descriptions and tags associated with each foundation model. The computer records the ranking score assigned to and the set of use cases supported by each foundation model of the plurality of foundation models in an n-dimensional tensor. As a result, illustrative embodiments provide a technical effect of recording the ranking score assigned to and the set of use cases supported by each foundation model of the plurality of foundation models in an n-dimensional tensor.

The computer also receives the prompt that contains a set of details from a client device user. The set of details includes at least one of an instruction, a set of examples, a context, and a question. The computer extracts the set of details from the prompt in response to receiving the prompt. As a result, illustrative embodiments provide a technical effect of extracting the set of details that includes at least one of an instruction, a set of examples, a context, and a question from the prompt in response to receiving the prompt.

In addition, the computer performs an analysis of a set of details extracted from the prompt. The computer identifies the use case corresponding to the prompt based on the analysis of the set of details extracted from the prompt. As a result, illustrative embodiments provide a technical effect of identifying the use case corresponding to the prompt based on the analysis of the set of details extracted from the prompt.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

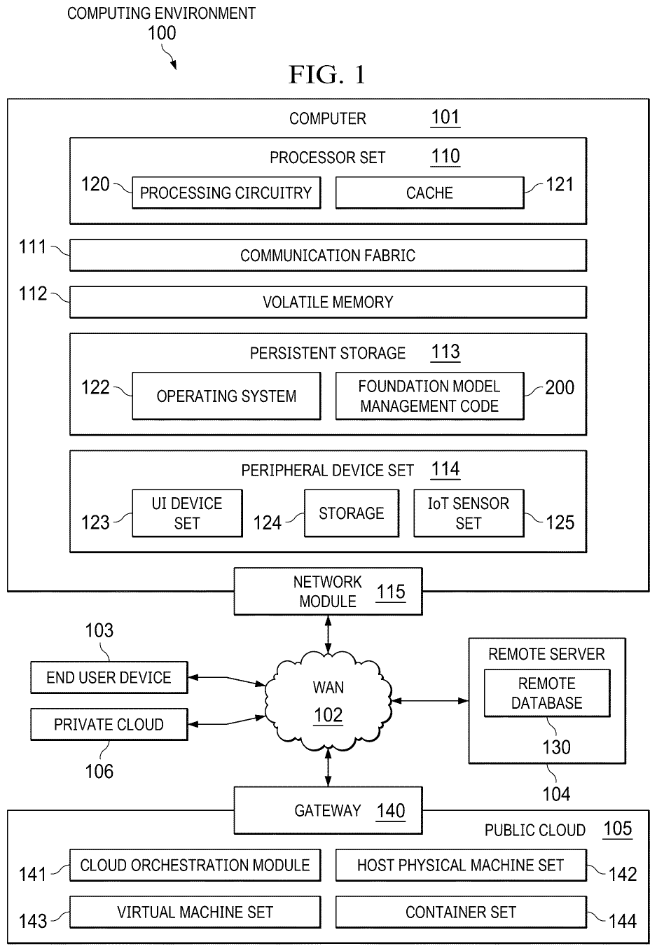

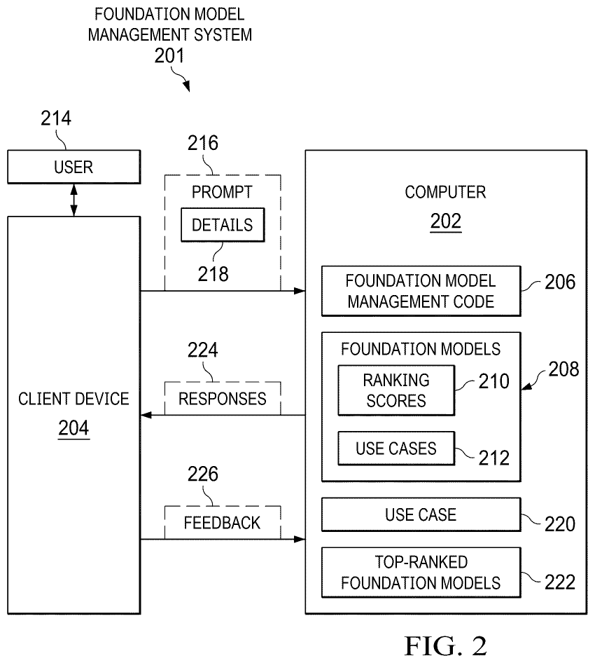

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as foundation model management code 200.

For example, foundation model management code 200 dynamically ranks and selects foundation models based on use case associated with a prompt submitted by a user. It should be noted that a user may be a human or AI agent. By illustrative embodiments using foundation model management code 200, the user does not need to select a foundation model before receiving a foundation model-generated response to the prompt. Instead, the user merely provides prompt details that include, for example, an instruction, examples, and context. Foundation model management code 200 utilizes the prompt details, along with historical feedback regarding foundation model selection for same or similar use cases from other users, to rank and select available foundation models to generate responses to the user-provided prompt details from a defined number of top-ranked foundation models. Foundation model management code 200 then presents the generated responses to the user to choose the response that works best for the user. Further, the user may provide feedback which foundation model management code 200 collects as a feedback signal to continually improve the foundation model ranking and selection process performed by foundation model management code 200.

Thus, foundation model management code 200 can dynamically rank and select foundation models without requiring users to specifically select a foundation model to generate a response to a prompt. In other words, intelligence is built into foundation model management code 200 to identify which set of foundation models is best for a particular use case corresponding to a received prompt from a user. For example, foundation model management code 200 may include a specialized LLM component.

In addition to foundation model management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and foundation model management code 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. In addition, computer 101 may be a generative AI platform. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in foundation model management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a user who submits a prompt to utilize the foundation model management services provided by computer 101), and may take any of the forms discussed above in connection with computer 101. EUD 103 typically receives helpful and useful data from the operations of computer 101. For example, in a hypothetical case where computer 101 is designed to provide a foundation model recommendation to the end user, this recommendation would typically be communicated from network module 115 of computer 101 through WAN 102 to EUD 103. In this way, EUD 103 can display, or otherwise present, the foundation model recommendation to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a foundation model recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

Recent achievements in generative artificial intelligence (AI) and associated foundation models have generated a lot of interest. This interest has translated to several vendors offering generative AI platforms that provide proprietary and open-source foundation models as a service where users can explore the different foundation models to use in their applications. Currently, thousands of foundation models are available through various generative AI platforms with varying degrees of performance across different use cases. Going forward, the number of available foundation models will most likely increase reflecting new architectures and optimizations for various tasks, datasets, and use cases.

While the number and variety of foundation models may continue to increase, this increasing number of foundation models will present a challenge for end users in terms of selecting which foundation model is appropriate to utilize for a given use case. Existing solutions for selecting foundation models are limited to high-level categorization and filtering of foundation models based on the description of use cases. One existing foundation model selection website hosts a large number of open-source foundation models where users can search by category (e.g., natural language processing, computer vision, multimodal, or the like) and use case (e.g., summarization, text generation, conversational, or the like).

However, this searching and filtering approach of existing solutions is limited because this searching and filtering approach is based on using tags associated with the different foundation models. Additionally, this searching and filtering approach of existing solutions still presents a relatively large number of foundation models to users, which can leave the users confused or having to do additional research or experiments to determine which is the best foundation model to use for their specific use case. For example, existing solutions sort foundation models by what is trending, most likes, most downloads, and recently updated, but not by relevance to use cases.

In contrast, illustrative embodiments dynamically rank and select foundation models based on the use case associated with the prompt submitted by a user to a generative AI platform. It should be noted that illustrative embodiments are extensible to all types of foundation models, such as, for example, LLMs and the like.

Assume the generative AI platform offers a plurality of foundation models. Also, the generative AI platform includes high-level descriptions and tags for the foundation models available on the generative AI platform. These high-level definitions and tags serve to provide a static categorization of the available foundation models on the generative AI platform. Further, the generative AI platform includes defined use cases that are supported by the available foundation models. The defined use cases may include, for example, summarization, entity extraction, sentiment analysis, question-answering, text generation, and the like.

Illustrative embodiments assign an initial ranking score for each foundation model available on the generative AI platform based on a set of use cases supported by each of the foundation models using their corresponding high-level descriptions and tags. Alternatively, illustrative embodiments may set the initial ranking score to zero for all of the foundation models. As another alternative, illustrative embodiments may obtain ranking scores for foundation models from an external source, such as, for example, a third party foundation model provider. In addition, illustrative embodiments can assign the same initial ranking score to all foundation models corresponding to a particular use case. In other words, illustrative embodiments initialize ranking scores based on some high-level information. Illustrative embodiments record the ranking scores of the foundation models in an n-dimensional tensor, where the n-dimensions capture the specific details of each prompt such as corresponding use case, structure of the instruction, number of examples, and context.

Subsequently, a user accesses the generative AI platform and inputs a prompt. It should be noted that the user utilizing illustrative embodiments does not need to select a specific foundation model to generate a response to the prompt. In response to receiving the prompt, illustrative embodiments decompose, fragment, or break down the prompt into its various details or components. The details of the prompt include the instruction, a set of examples (if provided) for one-shot or few-shot learning, context, and question. The instruction defines the task that the foundation model is to perform. The set of examples provides specific instances or situations corresponding to the task to be performed by the foundation model for one-shot or few-shot learning by the foundation model. If the user does not provide an example in the prompt, that is referred to as zero-shot learning. The context refers to the background information that helps the foundation model understand the input to provide a response to the prompt. The question causes the foundation model to perform the task defined in the instruction.

Illustrative embodiments analyze the details of the prompt that include the instruction, examples, and context to determine the structure of the instruction (e.g., is the instruction a free text instruction or a detailed step-by-step instruction), the number of examples provided for zero-shot, one-shot, or few-shot learning by a foundation model, and the data providing the context (e.g., is the data one large blob of text, multiple paragraphs of text, or the like). Illustrative embodiments identify a use case corresponding to the prompt based on the analysis of the instruction, examples, and context provided in the prompt using, for example, multi-class text classification.

Illustrative embodiments identify a group of particular foundation models that support the use case corresponding to the prompt in the generative AI platform by performing a search of the n-dimensional tensor. In addition, illustrative embodiments identify a ranking score associated with each respective foundation model of the group of particular foundation models that support the use case corresponding to the prompt based on the search of the n-dimension tensor. Further, illustrative embodiments rank each respective foundation model of the group of particular foundation models that support the use case corresponding to the prompt from a highest ranking foundation model to a lowest ranking foundation model based on the ranking score associated with a particular foundation model.

Illustrative embodiments select a defined number of top-ranked foundation models that support the use case corresponding to the prompt to generate responses to the prompt based on the rank of each respective foundation model. The user can configure or set the defined number of top-ranked foundation models. For foundation models that have the same ranking score, illustrative embodiments can randomly select one of the foundation models or sort the foundation models based on speed, cost, or the like.

Illustrative embodiments run the prompt against the defined number of top-ranked foundation models to generate the responses to the prompt. Illustrative embodiments receive the responses to the prompt from the defined number of top-ranked foundation models. Illustrative embodiments then provide the responses to the prompt to the user for review. The user may select a response or a set of responses to the prompt that the user likes best. Typically, the user selects only one response to the query. Afterward, the user may proceed by submitting another prompt the generative AI platform or refining the original prompt for resubmission.

Illustrative embodiments may also provide the user with a rating option (e.g., a star rating scale from one to five stars, where one star is the worst rating and five stars is the best rating) for the different responses generated by the defined number of top-ranked foundation models. As a result, users can utilize the rating option to rate the foundation model responses in relation to the prompt. Illustrative embodiments use the information provided by the users via the rating option as feedback for illustrative embodiments to continually improve the foundation model ranking and selection process over time.

In addition, illustrative embodiments can increase the ranking score of a particular foundation model by some defined delta value in the n-dimensional tensor to reflect the observation by illustrative embodiments that the generated response by that particular foundation model was liked best by the user. Further, if the user provides a star rating for the various responses generated by the defined number of top-ranked foundation models, then illustrative embodiments can normalize the star ratings into a delta score to be added to the n-dimensional tensor. For example, if the user rates a generated response with five stars, then illustrative embodiments can adjust the ranking score of the foundation model that generated the response by the delta score. Similarly, if the user rates another generated response with four stars, then illustrative embodiments can adjust the ranking score of the foundation model that generated that response by 0.8*delta score. As more users utilize the generative AI platform, illustrative embodiments can continually update the ranking scores of the different foundation models available on the generative AI platform.

Moreover, illustrative embodiments can enable the user to go through multiple iterations or interactions with the generative AI platform before illustrative embodiments update the ranking scores of the foundation models. For example, throughout the multiple interactions, illustrative embodiments track the various ranking scores of different foundation models and update the ranking scores in a “local” sense, but only apply the ranking score updates to the n-dimensional tensor when user explicitly selects “save” or some other similar functionality.

Further, when selecting the defined number of top-ranked foundation models to generate responses to a received user query, illustrative embodiments may randomly select a subset number of the defined number of top-ranked foundation models. In other words, illustrative embodiments would select the defined number of top-ranked foundation models minus the subset number and then select the subset number randomly from the remaining pool of available foundation models. This random foundation model selection process would avoid a potential scenario where only a small group of foundation models would dominate the defined number of top-ranked foundation models consistently.

Furthermore, illustrative embodiments may utilize weighted learning where the weighted learning is triggered based on feedback from a social network or a work network corresponding to a particular user. For example, illustrative embodiments can define a first weight factor for social network feedback and a second weight factor for work network feedback. Illustrative embodiments would multiply a ranking score of a foundation model by the first weight factor or the second weight factor based on whether the feedback was provided by a member of the user's social network or the user's work network.

In addition, if a user opts in, illustrative embodiments can store the user's initial prompt submitted to the generative AI platform. When illustrative embodiments determine that similar prompts from other users resulted in responses generated by one or more other foundation models being selected by those other users, illustrative embodiments may send a notification to the user indicating that the one or more other foundation models may be useful for generating responses to the user's initial prompt.

Thus, illustrative embodiments provide one or more technical solutions that overcome a technical problem with existing solutions selecting foundation models based on what is trending, most liked, most downloaded, and recently updated rather than based on relevance to specific use cases. As a result, these one or more technical solutions provide a technical effect and practical application in the field of foundation models.

With reference now to FIG. 2, a diagram illustrating an example of a foundation model management system is depicted in accordance with an illustrative embodiment. Foundation model management system 201 may be implemented in a computing environment, such as computing environment 100 in FIG. 1. Foundation model management system 201 is a collection of hardware and software components for dynamically ranking and selecting foundation models based on use case associated with prompts submitted by users.

In this example, foundation model management system 201 includes computer 202 and client device 204. Computer 202 may be, for example, computer 101 in FIG. 1. In addition, computer 202 may be, for example, a generative AI platform. Client device 204 may be, for example, EUD 103 in FIG. 1. However, it should be noted that foundation model management system 201 is intended as an example only and not as a limitation on illustrative embodiments. For example, foundation model management system 201 may include any number of computers, client devices, and other devices and components not shown.

Computer 202 includes foundation model management code 206 such as foundation model management code 200 in FIG. 2. Foundation model management code 206 controls the ranking and selection of foundation models 208. Foundation models 208 represent a plurality of different types of foundation models that can perform a plurality of different tasks or functions.

Foundation model management code 206 generates ranking scores 210 for each of foundation models 208 based on use cases 212. Use cases 212 represent a plurality of different use cases. Each foundation model of foundation models 208 may support one or more use cases of use cases 212.

In this example, user 214 inputs prompt 216 into computer 202 via client device 204. Prompt 216 includes details 218. Details 218 include at least one of an instruction, a set of examples, a context, and a question.

In response to computer 202 receiving prompt 216, foundation model management code 206 extracts and analyzes details 218. Based on the analysis of details 218, foundation model management code 206 identifies a use case that corresponds to prompt 216. In this example, the use case that corresponds to prompt 216 is use case 220

In response to identifying use case 220 corresponding to prompt 216, foundation model management code 206 identifies a set of foundation models in foundation models 208 that support use case 220. Afterward, foundation model management code 206 orders the set of foundation models that support use case 220 in a list from highest to lowest ranking score based on the corresponding ranking score of each foundation model in the set.

Foundation model management code 206 then selects top-ranked foundation models 222 from the list. Top-ranked foundation models 222 represent a predefined number of top-ranked foundation models.

Foundation model management code 206 runs prompt 216 on top-ranked foundation models 222 to generate responses 224. Each of top-ranked foundation models 222 generates one response of responses 224.

Computer 202 sends responses 224 to client device 204 for user 214 to review. Upon review of responses 224, user 214 selects a particular response from responses 224. In addition, user 214 may rate each of responses 224 as to the degree each respective response was relevant or related to prompt 216.

User 214 may send at least one of the response selection and rating of each response as feedback 226 to computer 202. Foundation model management code 206 uses feedback 226 to adjust or modify ranking scores 210 that correspond to one or more of top-ranked foundation models 222 to improve the ranking and selection process.

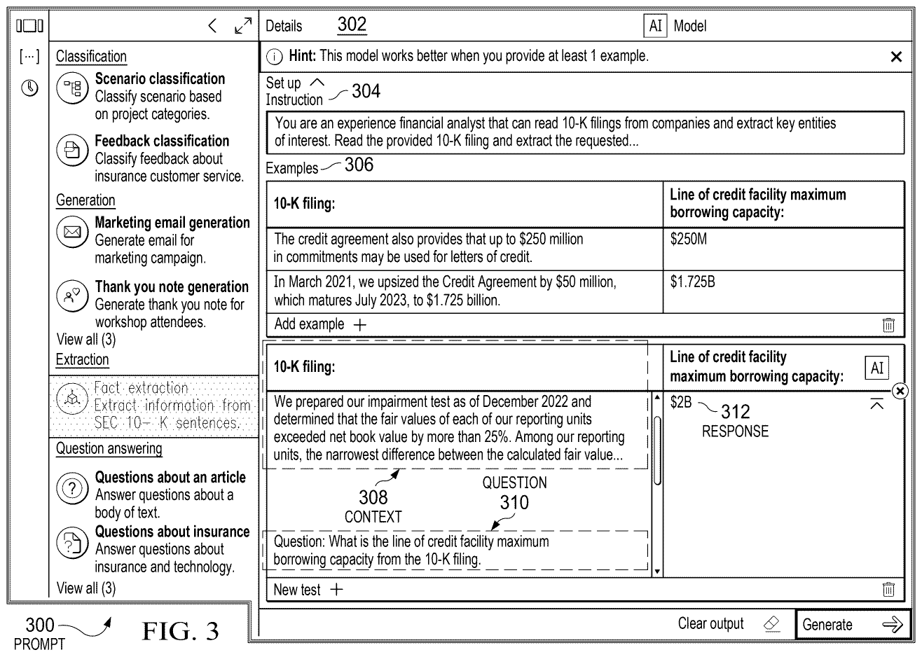

With reference now to FIG. 3, a diagram illustrating an example of a prompt is depicted in accordance with an illustrative embodiment. Prompt 300 may be, for example, prompt 216 in FIG. 2. Prompt 300 includes details 302 such as details 218 in FIG. 2.

In this example, details 302 include instruction 304, examples 306, context 308, and question 310. However, it should be noted that a user, such as user 214 in FIG. 2, does not need to include each of instruction 304, examples 306, context 308, and question 310 in prompt 300. For example, the user may not include examples 306 and/or question 310. Response 312 answers question 310.

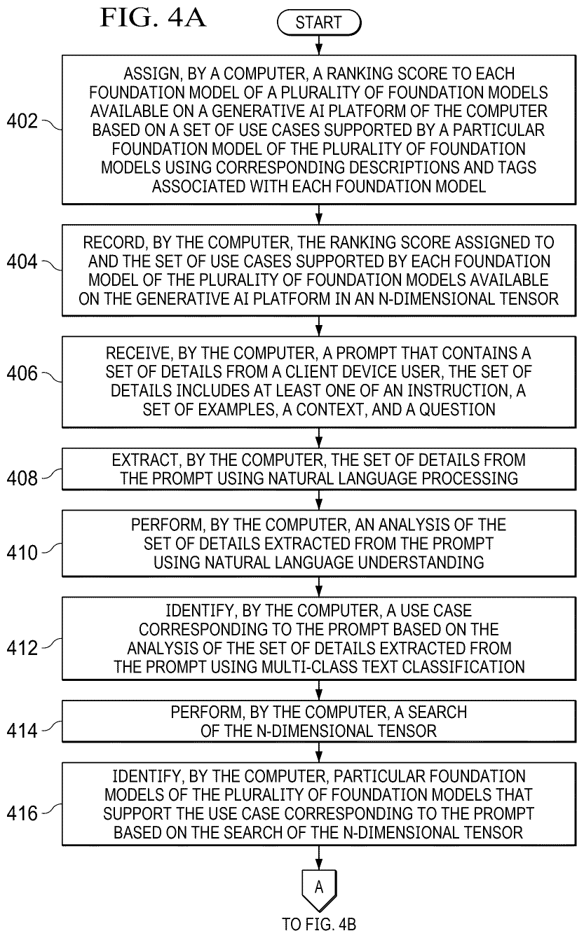

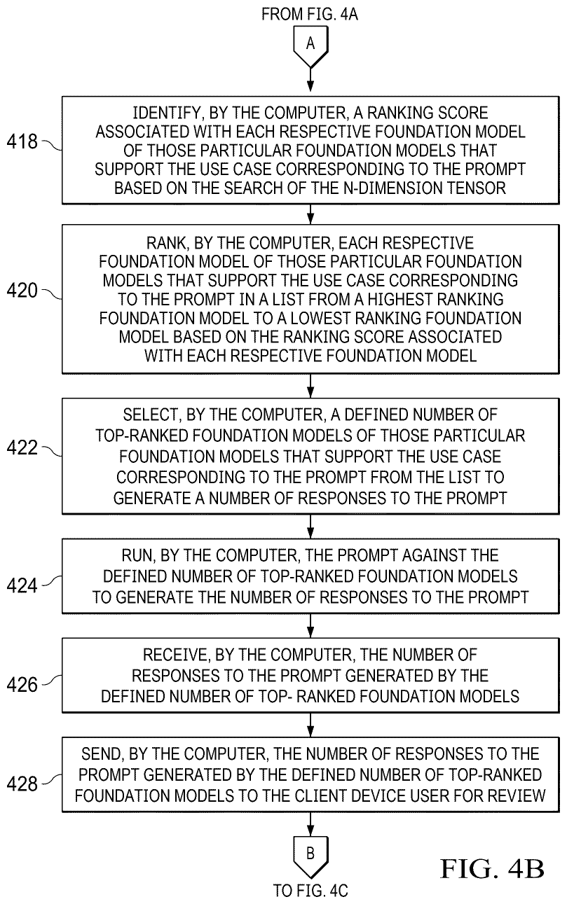

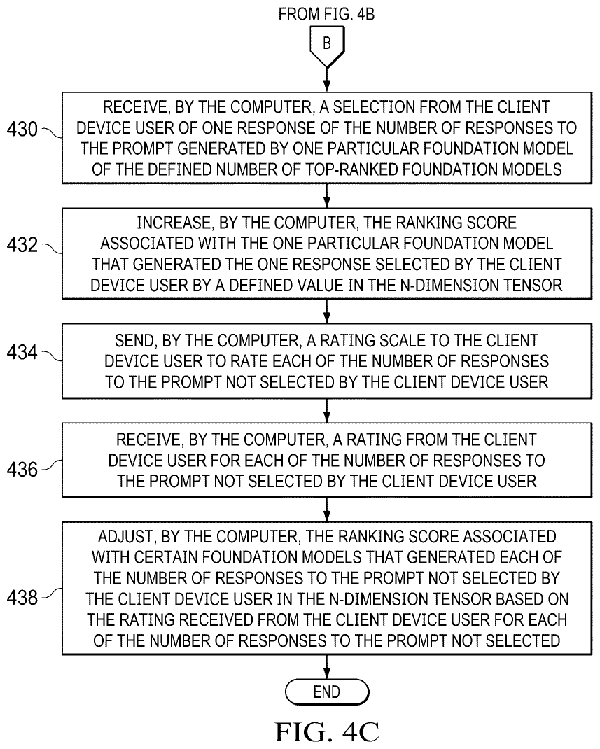

With reference now to FIGS. 4A-4C, a flowchart illustrating a process for use case driven foundation model ranking and selection is shown in accordance with an illustrative embodiment. The process shown in FIGS. 4A-4C may be implemented in a computer, such as, for example, computer 101 in FIG. 1 or computer 202 in FIG. 2. For example, the process shown in FIGS. 4A-4C may be implemented by foundation model management code 200 in FIG. 1 or foundation model management code 206 in FIG. 2.

The process begins when the computer assigns a ranking score to each foundation model of a plurality of foundation models available on a generative AI platform of the computer based on a set of use cases supported by a particular foundation model of the plurality of foundation models using corresponding descriptions and tags associated with each foundation model (step 402). In addition, the computer records the ranking score assigned to and the set of use cases supported by each foundation model of the plurality of foundation models available on the generative AI platform in an n-dimensional tensor (step 404).

Subsequently, the computer receives a prompt that contains a set of details from a client device user (step 406). The set of details includes at least one of an instruction, a set of examples, a context, and a question. The computer extracts the set of details from the prompt using natural language processing in response to receiving the prompt (step 408).

The computer performs an analysis of the set of details extracted from the prompt using natural language understanding (step 410). Further, the computer identifies a use case corresponding to the prompt based on the analysis of the set of details extracted from the prompt using multi-class text classification (step 412).

Afterward, the computer performs a search of the n-dimensional tensor (step 414). The computer identifies particular foundation models of the plurality of foundation models that support the use case corresponding to the prompt based on the search of the n-dimensional tensor (step 416). The computer also identifies a ranking score associated with each respective foundation model of those particular foundation models that support the use case corresponding to the prompt based on the search of the n-dimension tensor (step 418).

The computer ranks each respective foundation model of those particular foundation models that support the use case corresponding to the prompt in a list from a highest ranking foundation model to a lowest ranking foundation model based on the ranking score associated with each respective foundation model (step 420). The computer selects a defined number of top-ranked foundation models of those particular foundation models that support the use case corresponding to the prompt from the list to generate a number of responses to the prompt (step 422).

The computer runs the prompt against the defined number of top-ranked foundation models to generate the number of responses to the prompt (step 424). The computer receives the number of responses to the prompt generated by the defined number of top-ranked foundation models (step 426).

The computer sends the number of responses to the prompt generated by the defined number of top-ranked foundation models to the client device user for review (step 428). Subsequently, the computer receives a selection from the client device user of one response of the number of responses to the prompt generated by one particular foundation model of the defined number of top-ranked foundation models (step 430).

The computer increases the ranking score associated with the one particular foundation model that generated the one response selected by the client device user by a defined value in the n-dimension tensor (step 432). In addition, the computer sends a rating scale to the client device user to rate each of the number of responses to the prompt not selected by the client device user (step 434).

The computer receives a rating from the client device user for each of the number of responses to the prompt not selected by the client device user (step 436). The computer adjusts the ranking score associated with certain foundation models that generated each of the number of responses to the prompt not selected by the client device user in the n-dimension tensor based on the rating received from the client device user for each of the number of responses to the prompt not selected (step 438). Thereafter, the process terminates.

Thus, illustrative embodiments of the present disclosure provide a computer-implemented method, computer system, and computer program product for dynamically ranking and selecting foundation models based on use case associated with prompts submitted by users. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
extracting, by a computer, an instruction, a set of examples, a context, and a question from a prompt to identify a use case corresponding to the prompt in response to receiving the prompt;
ranking, by the computer, each respective foundation model of particular foundation models that support the use case corresponding to the prompt in a list from a highest ranking foundation model to a lowest ranking foundation model based on a ranking score associated with each respective foundation model;
selecting, by the computer, a defined number of top-ranked foundation models of the particular foundation models that support the use case corresponding to the prompt from the list to generate a number of responses to the prompt;
running, by the computer, the prompt against the defined number of top-ranked foundation models that support the use case corresponding to the prompt based on the instruction, the set of examples, the context, and the question to generate the number of responses to the prompt, wherein the instruction defines a natural language processing task that each top-ranked foundation model of the defined number of top-ranked foundation models is to perform, the set of examples provides specific instances corresponding to the natural language processing task to be performed by each top-ranked foundation model for learning by each top-ranked foundation model, the context provides background information to help each top-ranked foundation model provide a response to the prompt, and the question causes each top-ranked foundation model to perform the natural language processing task defined in the instruction;
receiving, by the computer, a selection from a client device user of one response of the number of responses to the prompt generated by one particular foundation model of the defined number of top-ranked foundation models;
increasing, by the computer, the ranking score associated with the one particular foundation model that generated the one response selected by the client device user by a defined value in an n-dimension tensor;
collecting, by the computer, feedback from the client device user regarding each of the number of responses to the prompt generated by the defined number of top-ranked foundation models; and
utilizing, by the computer, the feedback as a feedback signal to continually improve the ranking and the selecting of foundation models by the computer.

2. The computer-implemented method of claim 1, further comprising:
receiving, by the computer, the number of responses to the prompt generated by the defined number of top-ranked foundation models; and
sending, by the computer, the number of responses to the prompt generated by the defined number of top-ranked foundation models to the client device user for review.

3. (canceled)

4. The computer-implemented method of claim 1, further comprising:
sending, by the computer, a rating scale to the client device user to rate each of the number of responses to the prompt not selected by the client device user;
receiving, by the computer, a rating from the client device user for each of the number of responses to the prompt not selected by the client device user; and
adjusting, by the computer, the ranking score associated with certain foundation models that generated each of the number of responses to the prompt not selected by the client device user in the n-dimension tensor based on the rating received from the client device user for each of the number of responses to the prompt not selected.

5. The computer-implemented method of claim 1, further comprising:
assigning, by the computer, the ranking score to each foundation model of a plurality of foundation models based on a set of use cases supported by a particular foundation model of the plurality of foundation models using corresponding descriptions and tags associated with each foundation model; and
recording, by the computer, the ranking score assigned to and the set of use cases supported by each foundation model of the plurality of foundation models in an n-dimensional tensor.

6. The computer-implemented method of claim 1, further comprising:
receiving, by the computer, the prompt that contains the instruction, the set of examples, the context, and the question from the client device user.

7. The computer-implemented method of claim 1, further comprising:
performing, by the computer, an analysis of the instruction, the set of examples, the context, and the question extracted from the prompt; and
identifying, by the computer, the use case corresponding to the prompt based on the analysis of the instruction, the set of examples, the context, and the question extracted from the prompt.

8. The computer-implemented method of claim 1, further comprising:
performing, by the computer, a search of an n-dimensional tensor;
identifying, by the computer, the particular foundation models of a plurality of foundation models that support the use case corresponding to the prompt based on the search of the n-dimensional tensor; and
identifying, by the computer, the ranking score associated with each respective foundation model of the particular foundation models that support the use case corresponding to the prompt based on the search of the n-dimension tensor.

9. A computer system comprising:
a processor set;
one or more computer-readable storage media; and
program instructions stored on the one or more computer-readable storage media to cause the processor set to perform operations comprising:
extracting an instruction, a set of examples, a context, and a question from a prompt to identify a use case corresponding to the prompt in response to receiving the prompt;
ranking each respective foundation model of particular foundation models that support the use case corresponding to the prompt in a list from a highest ranking foundation model to a lowest ranking foundation model based on a ranking score associated with each respective foundation model;
selecting a defined number of top-ranked foundation models of the particular foundation models that support the use case corresponding to the prompt from the list to generate a number of responses to the prompt;
running the prompt against the defined number of top-ranked foundation models that support the use case corresponding to the prompt based on the instruction, the set of examples, the context, and the question to generate the number of responses to the prompt, wherein the instruction defines a natural language processing task that each top-ranked foundation model of the defined number of top-ranked foundation models is to perform, the set of examples provides specific instances corresponding to the natural language processing task to be performed by each top-ranked foundation model for learning by each top-ranked foundation model, the context provides background information to help each top-ranked foundation model provide a response to the prompt, and the question causes each top-ranked foundation model to perform the natural language processing task defined in the instruction;
receiving a selection from a client device user of one response of the number of responses to the prompt generated by one particular foundation model of the defined number of top-ranked foundation models;
increasing the ranking score associated with the one particular foundation model that generated the one response selected by the client device user by a defined value in an n-dimension tensor;
collecting feedback from the client device user regarding each of the number of responses to the prompt generated by the defined number of top-ranked foundation models; and
utilizing the feedback as a feedback signal to continually improve the ranking and the selecting of foundation models by the computer system.

10. The computer system of claim 9, wherein the operations further comprise:
receiving the number of responses to the prompt generated by the defined number of top-ranked foundation models; and
sending the number of responses to the prompt generated by the defined number of top-ranked foundation models to the client device user for review.

11. (canceled)

12. The computer system of claim 9, wherein the operations further comprise:
sending a rating scale to the client device user to rate each of the number of responses to the prompt not selected by the client device user;
receiving a rating from the client device user for each of the number of responses to the prompt not selected by the client device user; and
adjusting the ranking score associated with certain foundation models that generated each of the number of responses to the prompt not selected by the client device user in the n-dimension tensor based on the rating received from the client device user for each of the number of responses to the prompt not selected.

13. The computer system of claim 9, wherein the operations further comprise:
assigning the ranking score to each foundation model of a plurality of foundation models based on a set of use cases supported by a particular foundation model of the plurality of foundation models using corresponding descriptions and tags associated with each foundation model; and
recording the ranking score assigned to and the set of use cases supported by each foundation model of the plurality of foundation models in an n-dimensional tensor.

14. A computer program product comprising:
one or more computer-readable storage media; and
program instructions stored on the one or more computer-readable storage media to perform operations comprising:
extracting, by a computer, an instruction, a set of examples, a context, and a question from a prompt to identify a use case corresponding to the prompt in response to receiving the prompt;
ranking, by the computer, each respective foundation model of particular foundation models that support the use case corresponding to the prompt in a list from a highest ranking foundation model to a lowest ranking foundation model based on a ranking score associated with each respective foundation model;
selecting, by the computer, a defined number of top-ranked foundation models of the particular foundation models that support the use case corresponding to the prompt from the list to generate a number of responses to the prompt;
running, by the computer, the prompt against the defined number of top-ranked foundation models that support the use case corresponding to the prompt based on the instruction, the set of examples, the context, and the question to generate the number of responses to the prompt, wherein the instruction defines a natural language processing task that each top-ranked foundation model of the defined number of top-ranked foundation models is to perform, the set of examples provides specific instances corresponding to the natural language processing task to be performed by each top-ranked foundation model for learning by each top-ranked foundation model, the context provides background information to help each top-ranked foundation model provide a response to the prompt, and the question causes each top-ranked foundation model to perform the natural language processing task defined in the instruction;
receiving, by the computer, a selection from a client device user of one response of the number of responses to the prompt generated by one particular foundation model of the defined number of top-ranked foundation models;
increasing, by the computer, the ranking score associated with the one particular foundation model that generated the one response selected by the client device user by a defined value in an n-dimension tensor;
collecting, by the computer, feedback from the client device user regarding each of the number of responses to the prompt generated by the defined number of top-ranked foundation models; and
utilizing, by the computer, the feedback as a feedback signal to continually improve the ranking and the selecting of foundation models by the computer.

15. The computer program product of claim 14, wherein the operations further comprise:
receiving, by the computer, the number of responses to the prompt generated by the defined number of top-ranked foundation models; and
sending, by the computer, the number of responses to the prompt generated by the defined number of top-ranked foundation models to the client device user for review.

16. (canceled)

17. The computer program product of claim 14, wherein the operations further comprise:
sending, by the computer, a rating scale to the client device user to rate each of the number of responses to the prompt not selected by the client device user;
receiving, by the computer, a rating from the client device user for each of the number of responses to the prompt not selected by the client device user; and
adjusting, by the computer, the ranking score associated with certain foundation models that generated each of the number of responses to the prompt not selected by the client device user in the n-dimension tensor based on the rating received from the client device user for each of the number of responses to the prompt not selected.

18. The computer program product of claim 14, wherein the operations further comprise:
assigning, by the computer, the ranking score to each foundation model of a plurality of foundation models based on a set of use cases supported by a particular foundation model of the plurality of foundation models using corresponding descriptions and tags associated with each foundation model; and
recording, by the computer, the ranking score assigned to and the set of use cases supported by each foundation model of the plurality of foundation models in an n-dimensional tensor.

19. The computer program product of claim 14, wherein the operations further comprise:
receiving, by the computer, the prompt that contains the instruction, the set of examples, the context, and the question from the client device user.

20. The computer program product of claim 14, wherein the operations further comprise:
performing, by the computer, an analysis of the instruction, the set of examples, the context, and the question extracted from the prompt; and
identifying, by the computer, the use case corresponding to the prompt based on the analysis of the instruction, the set of examples, the context, and the question extracted from the prompt.
